(19) United States
(12) Patent Application Publication
(10) Pub. No.: US 2011/0242340 A1
(43) Pub. Date: Oct. 6, 2011

(54) IMAGE PICKUP ELEMENT UNIT, AUTOFOCUS UNIT, AND IMAGE PICKUP APPARATUS

(75) Inventors: Makoto Miyawaki, Yokohama-shi (JP); Hideaki Yamamoto, Kawasaki-shi (JP)

(73) Assignee: CANON KABUSHIKI KAISHA, Tokyo (JP)

(21) Appl. No.: 13/074,556

(22) Filed: Mar. 29, 2011

(30) Foreign Application Priority Data
Apr. 6, 2010 (JP) 2010-088010

(51) Int. Cl. H04N 5/232; H04N 5/228

(52) U.S. Cl. 348/208.12; 348/E05.045; 348/E05.031

(57) ABSTRACT

An image pickup element unit is used for an image pickup apparatus having an autofocus function configured to determine a direction in which an in-focus position is located by wobbling in an optical axis direction an image pickup element configured to photoelectrically convert an optical image formed by an image pickup optical system. The image pickup element unit includes a deformable member connected with the image pickup element and configured to deform when receiving a force, a support configured to support the deformable member and to serve as a fulcrum when the deformable member deforms so that the deformable member can move the image pickup element in the optical axis direction, and a weight fixed onto the deformable member and configured to move reverse to the image pickup element as the image pickup element moves.

### BACKGROUND OF THE INVENTION

1. Field of the Invention

The present invention relates to an image pickup element unit, an autofocus unit, and an image pickup apparatus.

2. Description of the Related Art

Japanese Patent Laid-Open No. (“JP”) 2003-279846 proposes an image pickup apparatus configured to determine a direction in which an in-focus position is located by wobbling an image pickup element in an optical axis direction of an image pickup optical system through a piezoelectric element, such as a bimorph device, in contrast type autofocus (“contrast AF”). Other prior art include JP 2003-98420.

The conventional image pickup apparatus has a problem in that the body of the image pickup apparatus vibrates when the image pickup element is being wobbled.

### SUMMARY OF THE INVENTION

The present invention provides an image pickup element unit, an autofocus unit, and an image pickup apparatus, which can mitigate or prevent vibrations during wobbling of an image pickup element.

An image pickup element unit according to one aspect of the present invention used for an image pickup apparatus having an autofocus function configured to determine a direction in which an in-focus position is located by wobbling in an optical axis direction an image pickup element configured to photoelectrically convert an optical image formed by an image pickup optical system includes a deformable member connected with the image pickup element and configured to deform when receiving a force, a support configured to support the deformable member and to serve as a fulcrum when the deformable member deforms so that the deformable member can move the image pickup element in the optical axis direction, and a weight fixed onto the deformable member and configured to move reverse to the image pickup element as the image pickup element moves.

Further features of the present invention will become apparent from the following description of exemplary embodiments with reference to the attached drawings.

### BRIEF DESCRIPTION OF THE DRAWINGS

FIGS. 1A and 1B are lateral and longitudinal sectional views of a body of an image pickup apparatus according to a first embodiment.

FIGS. 2A and 2B are perspective views of a principal part of front and back sides of the body illustrated in FIGS. 1A and 1B according to the first embodiment.

FIGS. 3A to 3C are enlarged sectional views of the image pickup element unit according to the first embodiment illustrated in FIGS. 1A and 1B.

FIG. 4 is a block diagram of the image pickup apparatus according to the first embodiment.

FIG. 5A is a partially transparent front view of a principal part of an image pickup element unit according to a second embodiment, and FIGS. 5B and 5C are its schematic top views.

FIGS. 6A and 6B are schematic top views of an image pickup element unit according to a third embodiment.

FIG. 7A is a partially transparent front view of a principal part of the image pickup element unit according to a fourth embodiment, and FIG. 7B is a top view of the image pickup element unit illustrated in FIG. 7A.

### DESCRIPTION OF THE EMBODIMENTS

Referring now to the accompanying drawings, a description will be given of embodiments of the present invention.

### First Embodiment

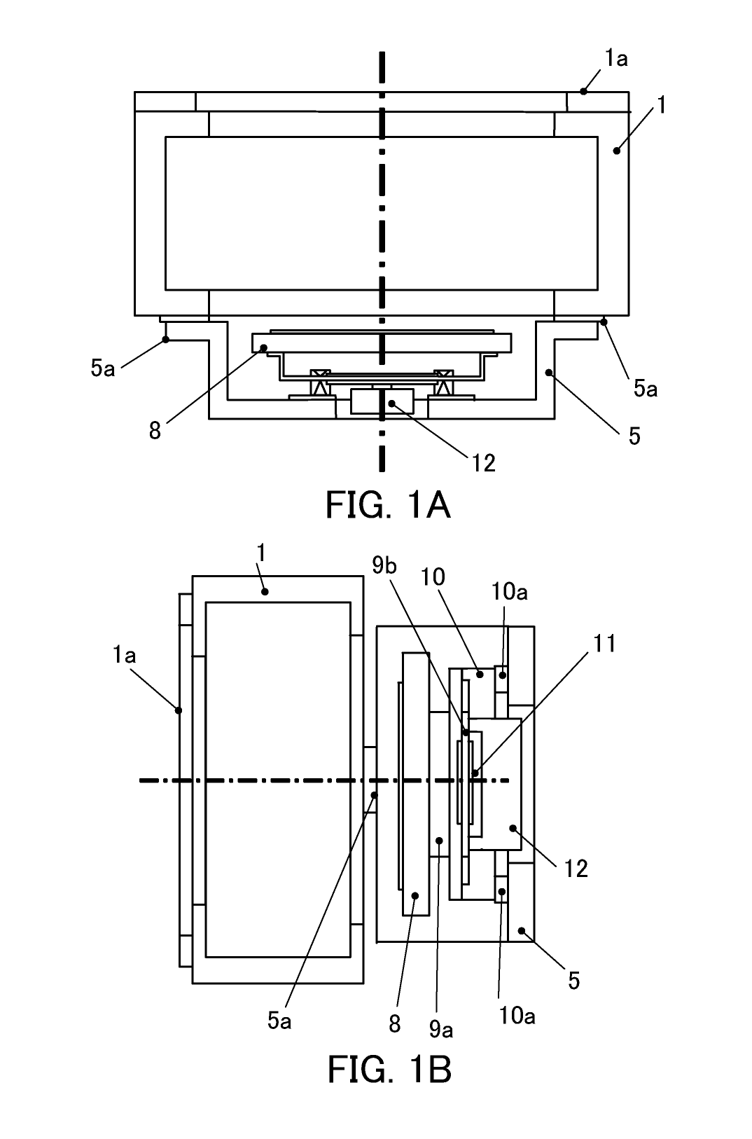

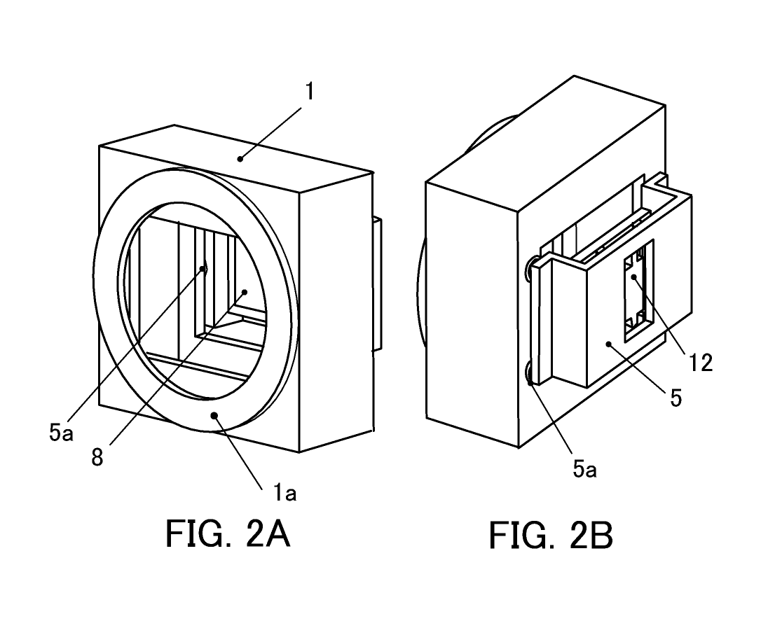

FIG. 1A is a lateral sectional view of a principal part of a body 1 of an image pickup apparatus, and FIG. 1B is a longitudinal sectional view of the principal part of the body. In these figures, an alternate long and short dash line denotes an optical axis. FIG. 2A is a perspective view of a principal part of the body 1 on the front side, and FIG. 2B is a perspective view of the principal part 1 of the rear side of the body 1.

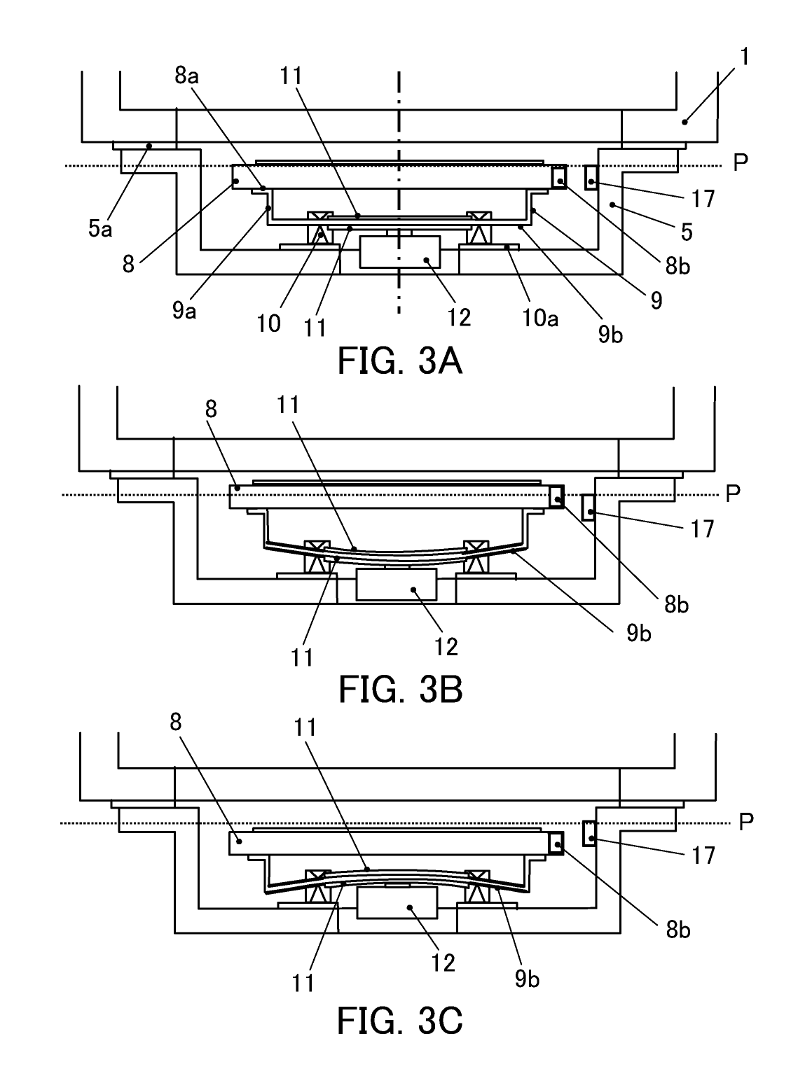

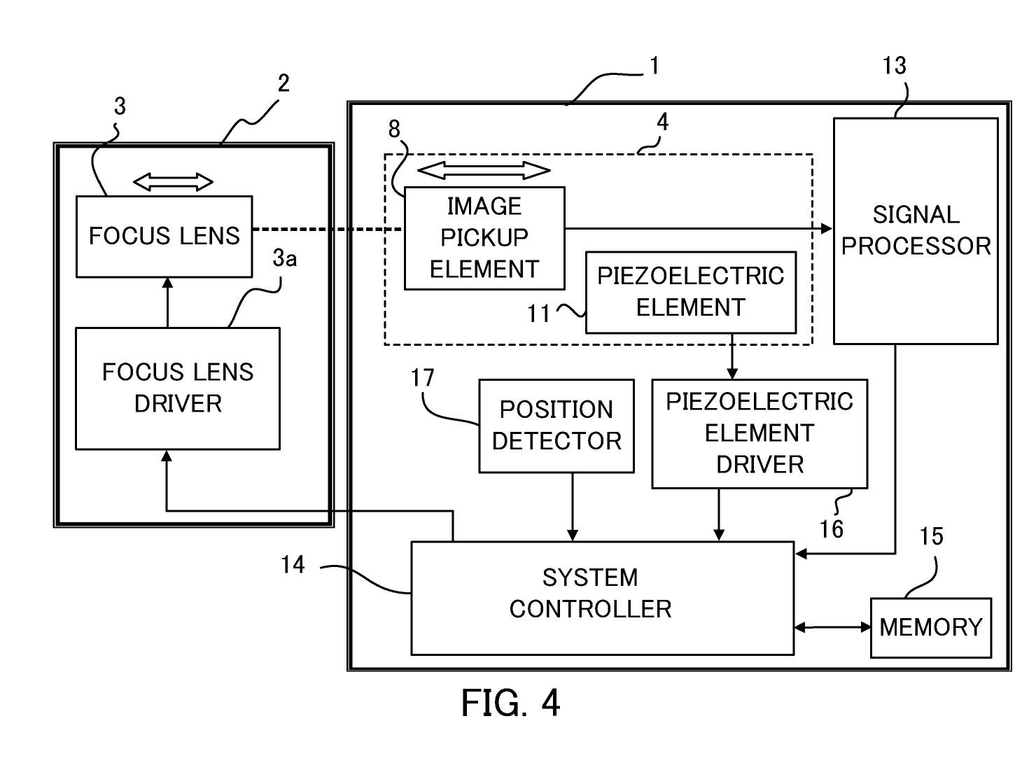

FIGS. 3A-3C are partially enlarged sectional views of the body 1. More specifically, FIG. 3A illustrates the image pickup element 8 located at a reference position, and an image pickup surface is located at an expected imaging plane P of a lens unit 2. FIG. 3B illustrates the image pickup element 8 that has moved forward, and FIG. 3C illustrates the image pickup element 8 that has moved backward. FIG. 4 is a block diagram of an image pickup apparatus.

In this embodiment, an object side may be referred to as a front side or forward direction and its opposite side may be referred to as a rear side or backward direction.

While the image pickup apparatus of this embodiment is a digital camera, its type is not limited, such as a digital still camera, a surveillance camera, a Web camera, and a camera mounted onto a cellular phone. The image pickup apparatus has an autofocus (“AF”) function configured to determine a direction in which an in-focus position (or a contrast peak position) is located by wobbling the image pickup element in the optical axis direction.

The image pickup apparatus includes, as illustrated in FIG. 4, the body 1, and the lens unit 2 that is exchangeably mounted on the body 1, but the image pickup apparatus of the present invention may be a lens integrated type. Mechanical attachment and detachment between the body 1 and the lens unit 2 are performed via a mount 1a of the body 1 illustrated in FIG. 1 and a mount (not illustrated) of the lens unit 2.

The lens unit 2 includes an image pickup optical system configured to form an optical image of an object. The image pickup optical system includes a plurality of lenses configured to condense the optical image of the object onto the image pickup element 8. A plurality of lenses partially includes a focus lens 3 for focusing, which is configured to move in the optical axis direction. The focus lens 3 is driven by a focus driver 3a, and a system controller 14 of the body 1 controls driving by the focus driver 3a. Focusing may be achieved only by moving the image pickup element 8 and the focus lens 3 may be omitted.

The body 1 includes an image pickup element unit 4, a signal processor 13, a system controller 14, a memory 15, a piezoelectric element driver 16, a position detector 17, and other components.

The image pickup element unit is enclosed by a dotted line in FIG. 4, and includes a detector pedestal 5, an image pickup element 8, sheet metal 9, a pair of supports 10, a piezoelectric element 11, and a weight 12.

The detector pedestal 5 forms a housing of an image pickup element unit. The detector pedestal 5 is attached to the body 1 so that the height of the detector pedestal 5 can be adjusted, for example, by adjustment washers 5a provided at three locations. Thereby, a position of the detector pedestal 5 can be separated from the mount 1a by a predetermined distance, and the detector pedestal 5 can maintain the flatness orthogonal to the optical axis of the lens unit 2.

The image pickup element 8 is a CMOS or CCD, configured to photoelectrically convert an optical image formed by the image pickup optical system, and to wobble in the optical axis direction of the image pickup optical system in the contrast AF. The image pickup element 8 has an electrode 8a on a rear surface.

The sheet metal 9 is a thin component made, for example, of the 42 alloy material that is an alloy between nickel and iron. The sheet metal 9 has an approximately U-shaped section made by bending a rectangular plate material, and includes a central plane (horizontal) part 9b and a pair of arms (perpendicular parts) 9a approximately bent by a right angle at both ends of the plane part 9b. The plane part 9b is perpendicular to the optical axis direction and a pair of arms 9a extends parallel to the optical axis direction.

A tip of the arm 9a is precisely soldered onto the electrode 8a of the image pickup element 8 so that the plate part 9b of the sheet metal 9 can be approximately parallel to the image pickup plane of the image pickup element 8. One end of each arm 9a is coupled with the plane part 9b, and the other end of each arm 9a is coupled with the image pickup element 8. As a result, the sheet metal 9 can deform in the thickness (or optical axis) direction around its center so that the image pickup plane of the image pickup element 8 can maintain the parallelism.

The metal sheet 9 is mounted with the piezoelectric elements 11 and the weight 12, and serves as an elastically deformable member configured to move the image pickup element 8 in the optical axis direction when receiving a force. The metal sheet 9 may be connected with the image pickup element 8 directly as in this embodiment or indirectly via another component.

The plane part 9b of the metal sheet 9 is a driven part that is elastically deformable when receiving a driving force from the piezoelectric element 11 at the wobbling time, and can displace the arms 9a via the supports 10 along the optical axis direction. The pair of arms 9a is a displaceable part connected to both ends of the plane part 9b and configured to move the image pickup element 8.

The plane part 9b has a front surface on the object side and a back surface opposite to the front surface. The piezoelectric elements 11 are fixed onto the front surface and the back surface of the plane part 9b. The plane part 9b, the pair of arms 9a, and the plane part of the image pickup element 8 are coupled with one another and form a four-node link. Hence, the image pickup element 8 is moved back and forth while its parallelism is maintained.

The pair of supports 10 are provided to hold the plane part 9b from the top and bottom outside the parts onto which the piezoelectric elements 11 are fixed on the front and back surfaces of the plane part 9b. The weight 12 is fixed onto the back surface of the plane part 9b.

The pair of supports 10 serve as a fulcrum when the sheet metal 9 deforms, and sandwich the sheet metal 9 from the top and the bottom. The pair of supports 10 are attached to the detector pedestal 5 via the adjustment washers 10a so that their positions can be adjustable, and determine positions of the sheet metal 9 and the image pickup element 8 relative to a reference of the image pickup apparatus.

Two adjustment washers 10a are provided at end of the support 10 in the width direction of the sheet metal 9, and there are totally four adjustment washers 10a. Although the number of the supports 10 is not limited, the supports 10 may be symmetrically provided to the plane part 9b with respect to the optical axis and symmetrically provided to the front and back surfaces of the plane part 9b.

The supports 10 support and hold the sheet metal 9 at approximately equidistant positions from the center of the sheet metal 9 near the node positions of the deflections of the piezoelectric elements 11, and support the sheet metal 9 and the image pickup element 8 without being affected by the deflections of the piezoelectric elements 11.

Each support 10 is fixed onto the body 1, and serves as a fulcrum when the plane part 9b of the sheet metal 9 elastically deforms. Therefore, displacements of the pair of arms 9a can be made stable. Since a thick plate is formed by pasting the piezoelectric elements on both surfaces of the sheet metal 9 that is a thin plate, the twisting rigidity of the plane part 9b becomes higher than that of the thin plate. Thus, the horizontalness can be maintained by supporting the plane part 9b using the supports 10 against the own weight of the image pickup element 8 and the vertically downward force caused by the gravity.

The supports 10 may be part of the body 1. The support 10 may have an adjustment unit configured to adjust a position of the image pickup element 8 in the optical axis direction.

The pair of piezoelectric elements 11 are attached to the centers of the front and back surfaces of the plane part 9b of the sheet metal 9. The piezoelectric elements 11 serve as driving means for wobbling the image pickup element 8 via the pair of arms 9a by deforming the plane part 9b.

The piezoelectric element 11 of this embodiment is a piezoelectric ceramic device having a thin plate shape, such as lead zirconate titanate (“PZT”), is pasted onto the front and back surfaces of the sheet metal 9, and forms a so-called bimorph structure together with the sheet metal 9. The paste number of the piezoelectric elements 11 is not limited. The piezoelectric element 11 is connected to the piezoelectric element driver 16 including a voltage source, and a voltage application (a voltage amount and application timing) to each piezoelectric element 11 is controlled by the system controller 14.

This embodiment adopts a parallel type connection method so as to extend and shrink the piezoelectric ceramics on the front and back surfaces of the sheet metal 9 in opposite directions by applying constant voltages to the piezoelectric elements 11 on the front and back surfaces of the sheet metal 9. When the sheet metal 9 deforms so that its front side can dent, the pair of arms 9a displace around the support 10 as a fulcrum and the image pickup element 8 moves forward along the optical axis direction (FIG. 3B). On the other hand, when the sheet metal 9 deforms so that its front side can project, the pair of arms 9a displace around the support 10 as a fulcrum and the image pickup element 8 moves backward along the optical axis direction (FIG. 3C). The displacement amount depends upon the magnitude of the voltage.

This embodiment pastes the piezoelectric element 11 onto the front and back surfaces of the sheet metal 9 one each, totally two piezoelectric elements 11. However, the piezoelectric electric element 11 may be pasted only onto a single surface of the sheet metal 9 and in that case, the deforming power becomes about half but the cost will be reduced.

The driver configured to drive the image pickup element 8 is not limited to a combination of the sheet metal 9 and the piezoelectric elements 11. For example, the driver may use a motor and the deformable member may use a linkage.

The weight 12 is fixed onto the back surface of the plane part 9b of the sheet metal 9, and configured to move in the optical axis direction reverse to the image pickup element 8 as the image pickup element 8 moves. The weight 12 serves to cancel or reduce the vibrations generated as a result of that the center of gravity of the image pickup element unit 4 moves as the image pickup element 8 is wobbled. While the weight 12 serves as a counterweight or counterbalance to maintain the balance of the image pickup element unit 4, it is sufficient to narrow the center of gravity movements to some extent and thus to maintain the balancing state to some extent.

The weight 12 of this embodiment is made of a material, such as brass, having large specific gravity and good heat radiation capability. In addition, the weight 12 has a multiplicity of heat-radiating fins, and its mass is equivalent to the mass of the image pickup element 8. The weight 12 is fixed onto the sheet metal 9 at two attachment positions upper and lower than the center of the back surface of the sheet metal 9, and does not affect the deformation of the sheet metal 9 by the piezoelectric elements 11.

The weight 12 may include a circuit substrate connected with the image pickup element 8. Thereby, a connecting part between the image pickup element 8 and the circuit substrate becomes so short that the noise reduction effect can increase and the space around the image pickup element can be made small.

A ratio between a stroke of moving the image pickup element 8 and a stroke of moving the weight 12 is variable by adjusting an interval between the pair of supports 10 in the longitudinal direction of the sheet metal 9. In addition, in the width direction of the sheet metal 9, the inclination of the imaging plane of the image pickup element 8 is changed by using the adjustment washers 10a to change the height of the support 10 in the optical axis direction and to twist the sheet metal 9. Thus, through fine adjustments of the positions of the supports 10 in the longitudinal direction or lateral direction or inclination direction, the image pickup plane of the image pickup element 8 can be prevented from inclining to the optical axis even when there are manufacturing errors among the components.

For better understandings, by adjusting a lever ratio determined by the interval between the pair of supports 10 and the interval between the pair of support 10 and the arm of the sheet metal 9, the stroke of moving forward the image pickup element 8 from the reference position is equalized to the stroke of moving backward the weight 12. Since the mass of the image pickup element 8 is equal to that of the weight 12, the vibrations of the image pickup apparatus caused when the image pickup element 8 is wobbled is cancelled and a photographer does not feel the vibrations. Of course, even in the circumstances different from those of this embodiment, a similar effect can be obtained by adjusting the lever ratio and the mass ratio between the image pickup element 8 and the weight 12.

Thus, the image pickup element 8 is moved in the optical axis direction while the inclination precision of the image pickup plane is guaranteed using the shape of the thin plate member. In addition, the vibrations are reduced using the weight 12 that moves reverse to the image pickup element 8, and the imaging state on the image pickup plane by the focus lens 3 is adjusted.

The signal processor 13 is connected to the image pickup element 8 and the system controller 14, receives and processes image information as an electric signal which has been photoelectrically converted by the image pickup element 8, and sends the resultant signal to the system controller 14. The signal processor 13 includes an A/D converter configured to convert the analog image signal from the image pickup element 8 into digital image data, a timing generator, an image processor, and a memory controller.

The system controller 14 is controlled by the image pickup element unit 4, the signal processor 13, and the memory 15, and is connected to a connector. The system controller 14 is a microcomputer (processor) configured to perform the AF controls including wobbling and image processing control, and to communicate with a lens controller (not illustrated) of the lens unit 2 and the connector.

The memory 15 stores constants, variables, and a variety of programs for operations of the system controller 14, and information necessary for the contrast AF. The piezoelectric element driver 16 drives the piezoelectric elements 11. The position detector 17, such as a Hall element, is configured to detect a position of the image pickup element 8 in the optical axis direction by detecting a position of a sensor magnet 8b provided to the image pickup element 8 (see FIGS. 3A to 3C). The position detector 17 may be part of the image pickup element unit 4.

The image pickup element unit 4, the signal processor 13, the system controller 14, and the memory 15 form an autofocus unit configured to determine the direction in which the in-focus position is located by wobbling the image pickup element 8 in the optical axis direction.

In the contrast AF, the image pickup element 8 or the focus lens is moved from its current position to the contrast peak position (in-focus position), and the image pickup element 8 is wobbled back and forth along the optical axis direction so as to determine the direction in which the in-focus position is located. Thus, the system controller 14 applies the voltage to the piezoelectric element 11 from the piezoelectric element driver 16 at the wobbling time.

FIG. 3A illustrates that no voltage is applied to the piezoelectric elements 11 and the image pickup plane of the image pickup element 8 accords with the expected imaging plane P. Here, the wobbling starts with the plus voltage application. Thereby, the image pickup element 8 moves forward, and the weight 12 moves backward, as illustrated in FIG. 3B. Due to the minus voltage application, the image pickup element 8 moves backward, and the weight 12 moves forward, as illustrated in FIG. 3C. Since the image pickup element 8 and the weight 12 always move reverse to each other, the shift of the center of gravity caused by the image pickup element 8 reduces and the vibrations transmitted to the body 1 are consequently reduced. In addition, the adjustable supports 10 provide the fine adjustment of the wobbling stroke of the image pickup element 8, and improve the inclination precision of the image pickup plane of the image pickup element 8.

Thus, the system controller 14 moves the image pickup element 8 back and forth from its current position, obtains a contrast value (AF evaluation value) at each position from the signal processor 13, and stores the value in the memory 15. Thereafter, the system controller 14 determines that the direction in which the AF evaluation value increases is the direction in which the in-focus position is located by comparing the obtained AF evaluation value with the AF evaluation value stored in the memory 15. Then, the system controller 14 moves either the focus lens 3 or the image pickup element 8 in the direction in which the in-focus position is located.

Next follows a description of an adjuster configured to adjust the distance and parallelism between the image pickup plane of the image pickup element 8 and the mount 1a. The adjuster is applicable to a lens-unit-exchangeable image pickup apparatus that does not move the image pickup element.

Initially, in order for the image pickup element 8 to move without inclining relative to the mount 1a at the wobbling time, the parallelism between the reference plane of the detector pedestal 5 and the image pickup plane of the image pickup element 8 is adjusted. Here, the distance between the image pickup plane of the image pickup element 8 and the reference plane of the detector pedestal 5 as a reference is measured at a plurality of locations with a laser displacement gage, and the adjustment washers 10a are adjusted so as to maintain the parallelism between the reference plane of the detector pedestal 5 and the image pickup plane of the image pickup element 8. At this time, the image pickup element 8 is driven and the distances are measured when the image pickup plane is located at the expected imaging plane P and at positions before and after the expected imaging plane P. Then, it is confirmed whether the image pickup plane can be moved back and forth by a predetermined stroke without inclinations, and any necessary adjustments are provided.

Next follows an adjustment using the adjustment washers 5a and the laser displacement gage so as to maintain equal a flange back distance that is the distance between the mount 1a and the image pickup plane of the image pickup element 8 and to maintain the parallelism between them.

### Second Embodiment

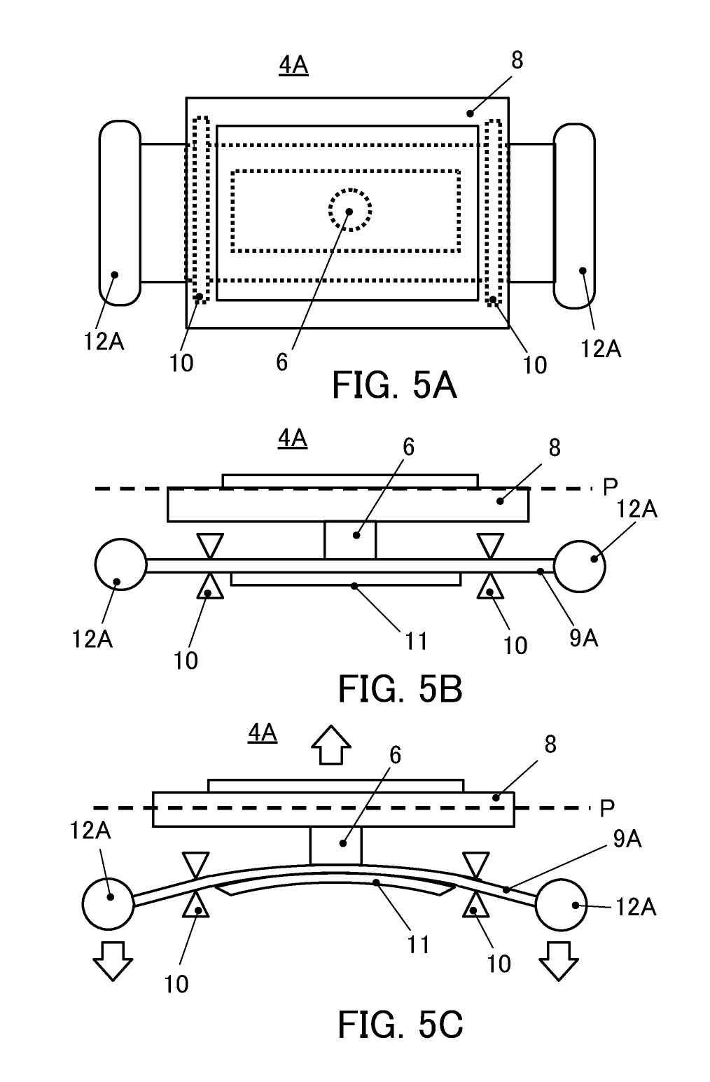

FIG. 5A is a partially transparent front view of an image pickup element unit 4A according to a second embodiment, and FIG. 5B is its top view. In FIG. 5B, the image pickup plane of the image pickup element 8 is located at the expected imaging plane P. FIG. 5C is a top view illustrating that the image pickup element 8 is moved ahead of the object side in the optical axis direction through wobbling from the state of FIG. 5B. A figure in which the image pickup element 8 is moved backward is omitted. The image pickup element unit 4A is different from the image pickup element unit 4 in having a sheet metal 9A having a plane shape and a pair of weights 12A.

The image pickup plane of the image pickup element 8 accords with in-focus position of the image pickup optical system on the expected imaging plane P, is perpendicular to the optical axis, and is coupled with the sheet metal 9A via a joint 6 attached to the rear surface of the image pickup element 8.

The sheet metal 9A is a planar-shaped, thin plate member, and its longitudinal direction accords with the longitudinal direction of the image pickup element 8. The joint 6 is fixed onto the surface on the object side at the center of the sheet metal 9A, and the piezoelectric element 11 of a unimorph type is fixed onto the center on the back surface on the photographer side. The front and back surfaces of the sheet metal 9A are supported by the pair of supports 10 outside of the part at which the piezoelectric element 11 is attached.

The pair of weights 12A are attached at both ends of the sheet metal 9A. Each weight 12A has half a mass of the image pickup element 8, and maintains the parallelism. In other words, the function of the sheet metal 9A is similar to that of the sheet metal 9, and the function of the weight 12A is similar to the weight 12.

As illustrated in FIG. 5C, as the piezoelectric element 11 deforms so that its front side can become convex, the image pickup element 8 is moved forward and the weights 12A are moved backward. As the piezoelectric element 11 deforms so that its front side can become concave, the image pickup element 8 is moved backward and the weights 12A are moved forward.

Since the image pickup element 8 and the weights 12A always move reverse to each other, the shift of the center of gravity caused by the image pickup element 8 reduces and the vibrations transmitted to the body are consequently reduced. In addition, the inclination precision of the image pickup plane of the image pickup element 8 can be secured at the wobbling time.

The flat sheet metal 9A can reduce scatters of deflections in the mass production and realize the stable stroke. In addition, the flat sheet metal 9A makes thinner the image pickup element unit 4A in the optical axis direction than the image pickup element unit having the bent-shaped sheet metal. Since the pair of weights 12A are arranged at both sides of the sheet metal 9A and each weight 12A does not overlap the image pickup element 8 in the optical axis direction, the image pickup element unit 4A can be made thinner than the image pickup element unit 4 in the optical axis direction.

### Third Embodiment

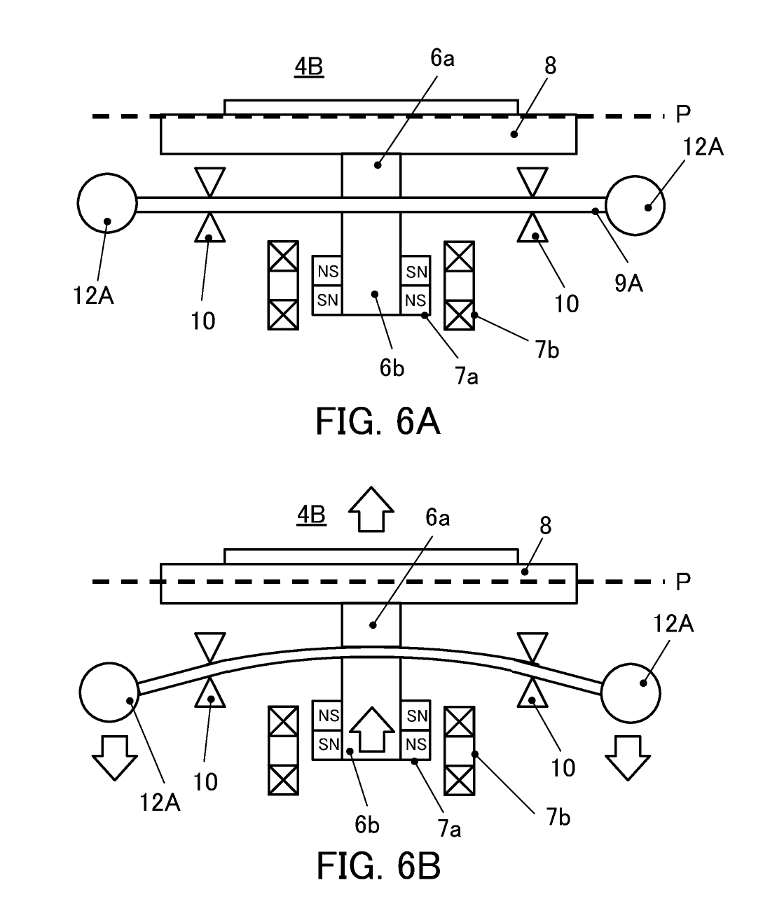

FIG. 6A is a top view of an image pickup element unit 4B, and FIG. 6B is a top view illustrating that the image pickup element 8 is moved ahead on the object side in the optical axis direction through wobbling from the state of FIG. 6A. A figure in which the image pickup element 8 is moved backward is omitted. The image pickup element unit 4B is different from the image pickup element unit 4A in using an electromagnetic drive unit instead of the piezoelectric element 11 for the driver.

A joint 6a is attached to the rear surface of the image pickup element 8 and is fixed onto a front surface of the sheet metal 9A. A joint 6b is fixed onto a rear surface of the sheet metal 9A. A pair of magnets 7a that is magnetized into two poles is fixed onto both ends of the joint 6b. A pair of coils 7b is fixed onto a fixing member (not illustrated) of the body of the image pickup apparatus.

The attraction or repulsion power to the magnet 7a occurs by changing the electrification direction to the coil 7b, and the front side of the sheet metal 9A may be made concave or convex by moving back and forth the joint 6b in the optical axis direction. As a result, the sheet metal 9A deforms around the supports 10 as a fulcrum, and the joint 6a moves back and forth the image pickup element 8 in the optical axis direction.

Since the image pickup element 8 and the weights 12A always move reverse to each other, the shift of the center of gravity caused by the image pickup element 8 reduces and the vibrations transmitted to the body are consequently reduced. In addition, the inclination precision of the image pickup plane of the image pickup element 8 can be secured at the wobbling time.

The flat sheet metal 9 can reduce scatters of deflections in the mass production and realize the stable stroke. In addition, the flat shape of the sheet metal 9A makes thinner the image pickup element unit 4B in the optical axis direction than the image pickup element unit having the bent-shaped sheet metal.

Since the pair of weights 12A are arranged at both sides of the sheet metal 9A and each weight 12A does not overlap the image pickup element 8 in the optical axis direction, the image pickup element unit 4B can be thinner than the image pickup element unit 4 in the optical axis direction. Furthermore, the sheet metal 9A is deformed by the electromagnetic driving method, and the durability improves because no component gets damaged in the impact of falling, etc.

### Fourth Embodiment

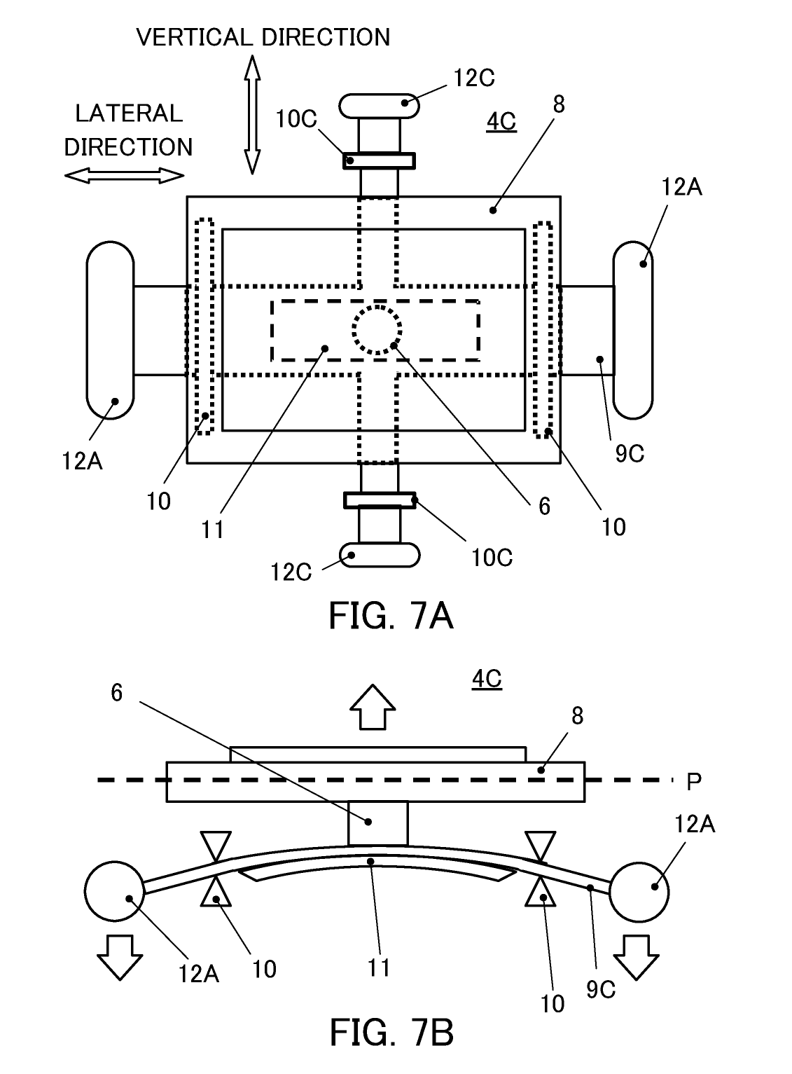

FIG. 7A is a partially transparent front view of an image pickup element unit 4C according to a fourth embodiment. FIG. 7B is a top view of the image pickup element unit 4C in which the image pickup element 8 is moved forward on the object side in the optical axis direction. The image pickup element unit 4C is different from the image pickup element unit 4A in using a sheet metal 9C having a cross plate shape, two pairs of supports 10 and 10C, and two pairs of weights 12A and 12C.

The sheet metal 9C is a flat thin member, and has a cross shape that extends in both the longitudinal and width directions of the image pickup element 8. However, the sheet metal 9C is made narrower in the width direction. The widthwise part of the sheet metal 9C is supported by the pair of supports 10C, and the pair of weights 12C are fixed onto both ends. The function of the sheet metal 9C is similar to that of the sheet metal 9, the function of the support 10C is similar to that of the support 10, and the function of the weight 12C is similar to that of the weight 12.

When the image pickup element unit 4C is arranged as illustrated in FIG. 7A, the gravity direction is a downward direction. In FIG. 7B, the image pickup element 8 is distant from the support 10 in the optical axis direction and it is conceivable that the sheet metal 9C may be deformed due to the gravity. The first to third embodiments solve this problem by increasing the width of the sheet metal or by pasting together the piezoelectric elements, and another countermeasure may thicken the sheet metal or add the bended part.

Similar to the second embodiment, when the image pickup element 8 is wobbled through the voltage control of the piezoelectric element 11, the sheet metal 9C in the width direction is narrow and does not affect the deflection by the piezoelectric element 11 in the longitudinal direction.

This embodiment can avoid large deformations of the sheet metal 9C in the vertical direction caused by the own weight of the image pickup element 8 and the gravity at the falling time, and prevent the inclination of the image pickup plane in the vertical direction. Therefore, in order to enhance the rigidity of the sheet metal in the vertical direction, it is unnecessary to increase the thickness of the sheet metal or to add the bended part. Since the thickness of the sheet metal can be made small, a large displacement amount of the piezoelectric element 11 can be maintained.

Also in this embodiment, since the image pickup element 8 and the weights 12A and 12C always move reverse to each other, the shift of the center of gravity caused by the image pickup element 8 reduces and the vibrations transmitted to the body 1 are consequently reduced. In addition, the inclination precision of the image pickup plane of the image pickup element 8 can be secured at the wobbling time.

The flat sheet metal 9C can reduce scatters of deflections in the mass production and realize the stable stroke. In addition, the flat sheet metal 9C makes thinner the image pickup element unit 4A in the optical axis direction than the image pickup element unit having the bent-shaped sheet metal.

Since two pairs of weights 12A and 12C are arranged on the four sides of the sheet metal 9C and the weights 12A and 12C do not overlap the image pickup element 8 in the optical axis direction, the image pickup element unit 4C can be thinner than the image pickup element unit 4.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-088010, filed Apr. 6, 2010 which is hereby incorporated by reference herein in its entirety.

What is claimed is:

1. An image pickup element unit used for an image pickup apparatus having an autofocus function configured to determine a direction in which an in-focus position is located by wobbling in an optical axis direction an image pickup element configured to photoelectrically convert an optical image formed by an image pickup optical system, the image pickup element unit comprising:
a deformable member connected with the image pickup element and configured to deform when receiving a force;
a support configured to support the deformable member and to serve as a fulcrum when the deformable member deforms so that the deformable member can move the image pickup element in the optical axis direction; and
a weight fixed onto the deformable member and configured to move reverse to the image pickup element as the image pickup element moves.

2. The image pickup element unit according to claim 1, further comprising an adjuster configured to adjust a position of the support in the optical axis direction.

3. The image pickup element unit according to claim 1, wherein the weight includes a circuit substrate connected to the image pickup element.

4. The image pickup element unit according to claim 1, wherein the deformable member has a flat shape.

5. The image pickup element unit according to claim 1, wherein the deformable member is pasted by a piezoelectric element.

6. The image pickup element unit according to claim 1, wherein the weight does not overlap the image pickup element in the optical axis direction.

7. An autofocus unit configured to determine a direction in which an in-focus position is located by wobbling, in an optical axis direction, an image pickup element configured to photoelectrically convert an optical image formed by an image pickup optical system, the autofocus unit comprising:
a deformable member connected with the image pickup element and configured to deform when receiving a force;
a support configured to support the deformable member and to serve as a fulcrum when the deformable member deforms so that the deformable member can move the image pickup element in the optical axis direction; and
a weight fixed onto the deformable member and configured to move reverse to the image pickup element as the image pickup element moves.

8. An image pickup apparatus comprising an autofocus unit configured to determine a direction in which an in-focus position is located by wobbling in an optical axis direction an image pickup element configured to photoelectrically convert an optical image formed by an image pickup optical system,
wherein the autofocus unit includes:
a deformable member connected with the image pickup element and configured to deform when receiving a force;
a support configured to support the deformable member and to serve as a fulcrum when the deformable member deforms such that the deformable member can move the image pickup element in the optical axis direction; and
a weight fixed onto the deformable member and configured to move reverse to the image pickup element as the image pickup element moves.
